(19) United States
(12) Patent Application Publication
(10) Pub. No.: US 2020/0327584 A1
(43) Pub. Date: Oct. 15, 2020

(54) System and Method for Ex-Offender Societal Reintegration

(71) Applicant: Dorian Ward, Jacksonville, FL (US)

(72) Inventor: Dorian Ward, Jacksonville, FL (US)

(21) Appl. No.: 16/829,310

(22) Filed: Mar. 25, 2020

Related U.S. Application Data
(60) Provisional application No. 62/832,368, filed on Apr. 11, 2019.

(51) Int. Cl. G06Q 30/02; G06Q 50/26

(52) U.S. Cl. CPC G06Q 30/0281; G06Q 50/265

(57) ABSTRACT

A societal reintegration system for ex-offenders. The system includes a software application for a computing device that enables an ex-offender to perform a plurality of tasks that facilitate reentry into and reintegration with society. The system includes features that enable the ex-offender to apply for a job, access an information repository that includes information on relevant reintegration topics, and a rating feature to enable ex-offenders to evaluate public servants, such as police officers.

### CROSS REFERENCE TO RELATED APPLICATIONS

This application claims priority under 35 U.S.C. § 119(e) to U.S. Provisional Application No. 62/832,368 filed on Apr. 11, 2019. The above identified patent application is incorporated by reference herein in its entirety to provide continuity of disclosure.

### BACKGROUND OF THE INVENTION

The present invention relates to a system and method for facilitating societal reintegration by an ex-offender. The system provides resources and information to help ex-offenders apply for jobs and financial aid packages for continuing education, and provide feedback to public servants such as police officers.

Many individuals previously convicted of crimes, i.e., ex-offenders, are vulnerable and often struggle to reintegrate with society after a conviction or a prison sentence. This difficulty can be due to the fact that many available jobs do not accept applicants who have been convicted of a crime, and these individuals may not be able to easily locate jobs that do accept applicants with a criminal conviction. In addition, some difficulty may arise due to ex-offenders not being fully and accurately informed about how to obtain services available to them, such as financial aid packages for continuing education. Further, many individuals may have experienced a positive or negative encounter with a public servant, such as a police officer.

If ex-offenders could more easily and effectively navigate the job market and education system, and be informed about opportunities available to them, these individuals may not rely on criminal behavior as a source of income, which may lead to another criminal conviction. Further, if these individuals could more easily communicate their experiences with public servants with other individuals, the criminal justice system may benefit. As a result, if ex-offenders could avoid further criminal behavior, both the ex-offenders and society may benefit.

Therefore, there is a need in the art for a system and method for facilitating societal reintegration by an ex-offender, which helps the ex-offender apply for jobs, apply for financial aid packages, and review or rate public servants, such as police officers. The present invention addresses this unmet need.

Systems and methods have been disclosed in the art that relate to applying for jobs, applying for financial aid packages, and reviewing or rating experiences. These include systems and methods that have been patented and published in patent application publications. These systems and methods are often unsatisfactory for ex-offenders and do not uniquely address or solve the problems experienced by this group. In view of the systems and methods disclosed in the art, it is submitted that there is a need in the art for an improvement to existing systems and methods that pertain to job applications, financial aid packages, and reviewing or rating experiences. In view of the present disclosure, it is submitted that the present invention substantially diverges in structural and functional elements from devices in the art, and substantially fulfills an unmet need.

### SUMMARY OF THE INVENTION

In view of the disadvantages inherent in the known types of systems and methods in the art, the present invention provides a new and improved system and method, wherein the same can be utilized for helping ex-offenders more easily and effectively perform various tasks related to societal reintegration.

It is therefore an object of the present invention to provide a computer-implemented method for applying for a job for an ex-offender, applying for a financial aid package for the ex-offender, and rating a public servant by the ex-offender.

In one aspect, the present invention provides a computer-implemented method for applying for a job for an ex-offender, comprising executing on a processor the steps of: receiving a first electronic communication, from a server, that pertains to the job in a computer that comprises a non-transitory computer-readable medium and the processor. The non-transitory computer-readable medium comprises processor-executable instructions, e.g., software, stored thereon for receiving and sending electronic communications. In various embodiments, the job accepts applicants who have been convicted of a criminal offense, and in this manner, the ex-offender may have a chance at getting the job. After receiving the first electronic communication, the method includes sending a second electronic communication that pertains to one or more of a qualification, the criminal offense, a skill, or a combination thereof of the ex-offender, from the computer to the server. In this manner, a functionality of the server stores, organizes, categorizes, reviews, and/or forwards the application for review.

In another aspect, the present invention provides a computer-implemented method for applying for a financial aid package for an ex-offender, wherein an application process of the financial aid package accepts applicants who have been convicted of a criminal offense. In this manner, the ex-offender can access financial aid needed to further his or her education and improve the chances of employment. In yet another aspect, the present invention provides a computer-implemented method for rating a public servant, wherein an ex-offender has experienced one or more interactions with the public servant. In such embodiments, if the ex-offender has had a positive or negative experience with the public servant, e.g., a police officer, the ex-offender can communicate information relating to the experience with others, such as other ex-offenders or members of the public.

In various embodiments, the computer comprises one or more computing devices selected from a group consisting of: a mobile phone, a tablet, a desktop computer, a laptop computer, and a combination thereof. In this manner, a software application of the present invention is able to be executed by one or more existing electronic devices.

In various embodiments, the second electronic communication comprises data that pertains to the ex-offender. In such embodiments, the ex-offender may send his or her resume, name and address, information about one or more criminal offenses, and the like, to the server for storage and retrieval by a third party.

In various embodiments, the non-transitory computer readable medium further comprises processor-executable instructions stored thereon for searching or querying the server based on a custom input. In this manner, the ex-offender can easily search and apply for a job, search and apply for a financial aid package, and/or search for and provide a review of a public servant such as a police officer. In such embodiments, the ex-offender can also view reviews provided by third parties and compare their experience therewith.

Another object of the present invention is to provide a system and method that may be readily manufactured from materials or approaches that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of the invention will be particularly pointed out in the claims, the invention itself and manners in which it may be made and used may be better understood after a review of the following description, taken in connection with the accompanying drawings, wherein like numeral annotations are provided throughout.

FIG. 1 depicts a perspective view of an exemplary user interface of a system of the present invention, in use to apply for a financial aid package.

FIG. 2 depicts a perspective view of the user interface of the system, after use to apply for the financial aid package.

FIG. 3 depicts a perspective view of the user interface of the system, in use to search and apply for a job.

FIG. 4 depicts a perspective view of the user interface of the system, in use to rate or review an experience with a public servant.

FIG. 5 depicts a perspective view of the user interface of the system, in use to rate or review the experience with the public servant.

### DETAILED DESCRIPTION OF THE INVENTION

Reference is made herein to the attached drawings. Like reference numerals are used throughout the drawings to depict like or similar elements of the invention. The figures are intended for representative purposes only and should not be considered limiting in any respect.

Generally, the present invention provides a system and method for assisting ex-offenders with reintegration into society. Oftentimes, societal reintegration requires an ex-offender to perform a plurality of tasks, such as working at a job, acquiring or furthering an education, and applying for financial aid packages. In such scenarios, however, the job and education systems may be perceived as biased against the ex-offender. For example, a large number of job openings may not be available to the ex-offender due to criminal history. This bias may be felt by hiring managers, who may prefer applicants with clear criminal background checks and histories. By effectively excluding the ex-offender from consideration, the ex-offender is more likely to not get the job and may resort to crime as a source of income. This perpetuates a cycle of unemployment and crime that is difficult to break.

The system of the present invention comprises a computer, i.e., a computing system, that is configured to enable the ex-offender to perform the method of the invention. The method is a computer-implemented method, and in some embodiments, may not be performed manually and may only be performed using the computer. In this manner, the method of the present invention is most preferably embodied by a customized computing system that enables the ex-offender to leverage remote networking, e.g., over an internet, and localized computer processing to perform the plurality of tasks to assist with reintegration.

In various embodiments, the computer comprises a processer, a non-transitory computer-readable medium, a display, a microphone, a speaker, and one or more controls configured to enable the ex-offender to operate and use a software program of the present invention. The non-transitory computer-readable medium may comprise the software program, e.g., processor-executable instructions, stored thereon, that is configured to enable the computer to receive, store, and send electronic communications. The electronic communications may be transmitted over a network, such as the world wide web, which may have any features suitable for a communication medium.

The computer-implemented method for applying for a job for an ex-offender comprises executing on a processor the step of receiving a first electronic communication, from a server, that pertains to the job in a computer that comprises a non-transitory computer-readable medium and the processor. The receiving the first electronic communication step may occur as a result of a request sent by the computer, and in this manner, existing or standard network transmission protocols may be followed by the system and method of the present invention. The non-transitory computer-readable medium comprises computer-readable instructions (i.e., processor-executable instructions; software) stored thereon for receiving and sending electronic communications. In various embodiments, the processor-executable instructions also include a set of instructions for the display and functionality of a graphical user interface, as shown in the Figures and as described elsewhere herein. In this manner, the processor-executable instructions may be controlled by an interaction with a user, such as an ex-offender.

In various embodiments, the job accepts applicants who have been convicted of a criminal offense, and in this manner, the ex-offender may have a chance at getting the job. In some such embodiments, the server maintains a list of jobs that accept applicants who have been convicted of a criminal offense. In this manner, the list may focus on this particular group of the population, and may not list jobs that do not accept applicants who have been convicted of a criminal offense.

After receiving the first electronic communication, the method includes executing on a processor the step of: sending a second electronic communication that pertains to one or more of a qualification, the criminal offense, a skill, or a combination thereof of the ex-offender, from the computer to the server. The second electronic communication may be stored in a database for future review by a third party. In this manner, a functionality of the server stores, organizes, categorizes, reviews, and/or forwards the application for review.

The computer-implemented method for applying for a financial aid package for an ex-offender comprises executing on a processor the step of receiving a first electronic communication, from a server, that pertains to the financial aid package in a computer that comprises a non-transitory computer-readable medium and the processor. The receiving the first electronic communication step may occur as a result of a request sent by the computer, and in this manner, existing or standard network transmission protocols may be followed by the system and method of the present invention. The non-transitory computer-readable medium comprises computer-readable instructions (i.e., processor-executable instructions; software) stored thereon for receiving and sending electronic communications. In various embodiments, the processor-executable instructions also include a set of instructions for the display and functionality of a graphical user interface, as shown in the Figures and as described elsewhere herein. In this manner, the processor-executable instructions may be controlled by an interaction with a user, such as an ex-offender.

In various embodiments, an application process of the financial aid package accepts applicants who have been convicted of a criminal offense, and in this manner, the ex-offender may have a chance at getting the package. In some such embodiments, the server maintains a list of financial aid packages that accept applicants who have been convicted of a criminal offense. In this manner the list may focus on this particular group of the population, and may not list financial aid packages that do not accept applicants who have been convicted of a criminal offense.

After receiving the first electronic communication, the method includes executing on a processor the step of: sending a second electronic communication that pertains to one or more of a name, the criminal offense, an address, or a combination thereof of the ex-offender, from the computer to the server. The second electronic communication may be stored in a database for future review by a third party. In this manner, a functionality of the server stores, organizes, categorizes, reviews, and/or forwards the application for review.

The computer-implemented method for rating a public servant comprises executing on a processor the step of receiving a first electronic communication, from a server, that pertains to the public servant in a computer that comprises a non-transitory computer-readable medium and the processor. The non-transitory computer-readable medium comprises processor-executable instructions (i.e., processor-executable instructions; software) stored thereon for receiving and sending electronic communications. In various embodiments, the processor-executable instructions also include a set of instructions for the display and functionality of a graphical user interface, as shown in the Figures and as described elsewhere herein. In this manner, the processor-executable instructions may be controlled by an interaction with a user, such as an ex-offender.

In various embodiments, an ex-offender has experienced one or more interactions with the public servant, and in this manner, is in a position to review their experience with the public servant. In some such embodiments, the server maintains a repository of public servant reviews. In this manner the repository may be useful to the public.

After receiving the first electronic communication, the method includes executing on a processor the step of: sending a second electronic communication that pertains to the one or more interactions (i.e., interactions with the public servant) from the computer to the server. The second electronic communication may be stored in a database for future review by a third party. In this manner, a functionality of the server stores, organizes, categorizes, reviews, and/or forwards the information for review.

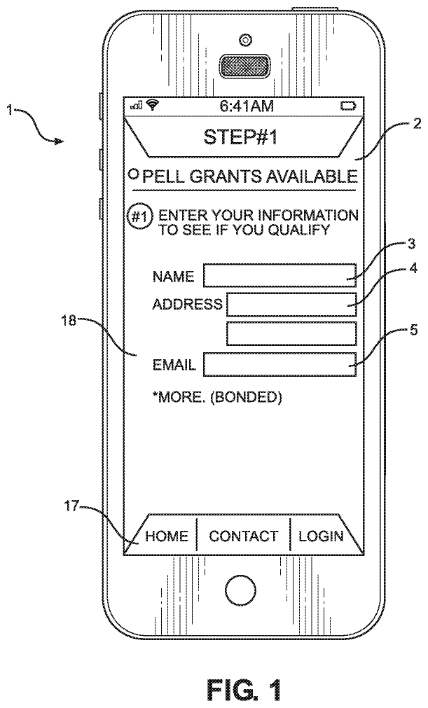

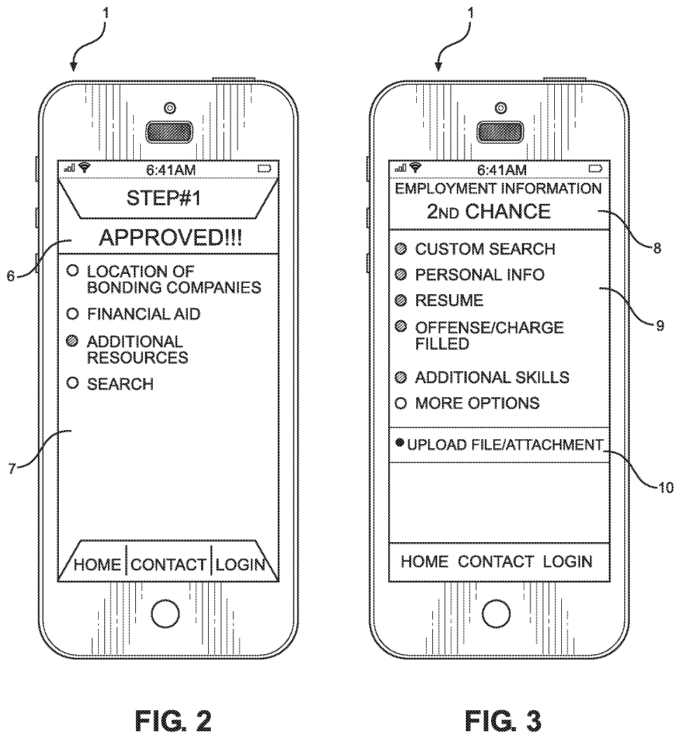

Referring now to FIGS. 1 and 2, there are depicted a perspective view of an exemplary user interface of a system of the present invention, in use to apply for a financial aid package (FIG. 1) and a perspective view of the user interface of the system, after use to apply for the financial aid package (FIG. 2). In some embodiments, two or more features of a system 1 may be utilized in combination or in tandem, or as individual steps as part of a reintegration program or method followed or performed by an ex-offender. In this manner, societal reintegration may be more successful.

In the shown embodiment, a first step for societal reintegration includes applying for a financial aid package, such as an educational grant, using the system 1. In the shown embodiment, a user interface of the system 1 includes a financial aid package header 2, a financial aid package body 18, and user input fields for a name 3, an address 4, and an electronic mail address 5. In various embodiments, the user interface of the system 1 includes a navigation panel 17 on a lower portion of the user interface. In the shown embodiment, the navigation panel 17 comprises a plurality of options, including “HOME”, “CONTACT”, and “LOGIN”. The home option may return the ex-offender to a home screen of the system 1, the contact option may display contact information for an author or a company associated with the system 1, and the login option may enable the ex-offender to log in to the system 1 and associate a username with an identifying detail that pertains to the ex-offender.

After application for the financial aid package is completed, if the applicant is approved for financial aid, the user interface may display an approval banner 6, as shown in FIG. 2. Underneath the approval banner 6, there may be a plurality of additional options 7 for the ex-offender, including but not necessarily limited to searching for a bonding company, obtaining additional information about financial aid, perusing additional resources pertaining to societal reintegration, and searching for more information.

Referring now to FIG. 3, there is depicted a perspective view of the user interface of the system, in use to search and apply for a job. In the shown embodiment, the user interface of the system 1 comprises an employment information banner 8, with an employment information body 9 and a file upload option 10. The employment information banner 8 may be displayed at an upper portion of a screen of a device of the system 1, and the employment information body 9 displayed at an intermediate portion of the screen.

In the shown embodiment, the employment information body 9 comprises various options for the ex-offender, including performing a customized search, providing personal information, viewing or editing a resume of the ex-offender, providing information about one or more criminal offenses or charged filed, providing information about additional skills of the ex-offender, and other options. In the shown embodiment, the file upload option 10 is positioned below the employment information body 9 and may be configured to enable the ex-offender to upload a document or file in support of a job application, such as the resume of the ex-offender. In this manner, the professionality of the ex-offender may be improved or maximized to improve the chance of the ex-offender receiving a job offer.

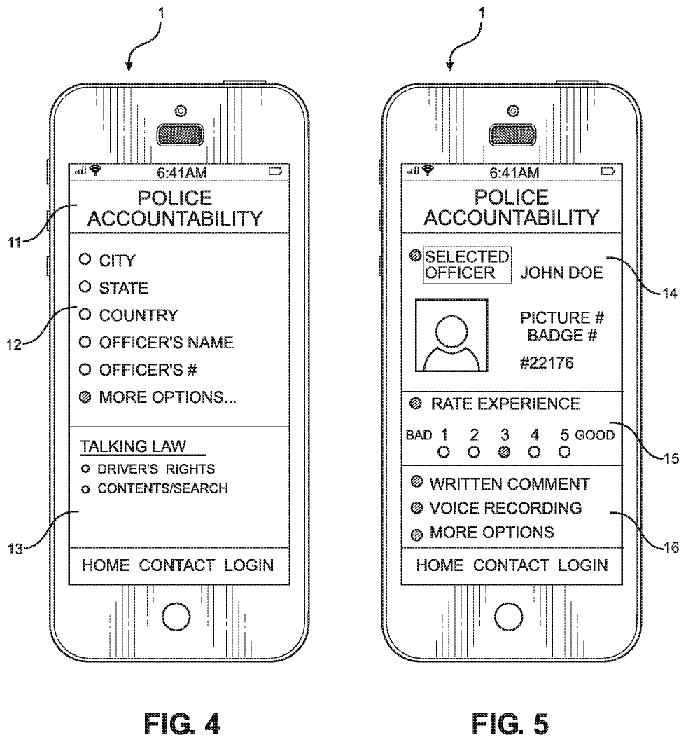

Referring now to FIG. 4, there is depicted a perspective view of the user interface of the system, in use to rate or review an experience with a public servant. In the shown embodiment, the system 1 includes a police accountability banner 11 positioned at an upper portion of the screen of the device and further includes a police accountability body 12 positioned below the banner 11. The police accountability body 12 comprises various search parameters for finding a particular police officer, such as entering information pertaining to a city, a state, a country, a name, and a number of the police officer. In this manner, the ex-offender can easily locate the particular police officer, e.g., an officer with whom the ex-offender has had one or more encounters or experiences with.

In the shown embodiment, the user interface of the system 1 further comprises a legal education section 13, which may provide educational information relating to driver's rights, contents or search, and the like. Because many ex-offenders may not have extensive knowledge of the law, this feature may assist the ex-offender with following the law. In such embodiments, activation of one or more features of the legal education section 13 may cause the system 1 to retrieve educational information from a server.

Referring now to FIG. 5, there is depicted a perspective view of the user interface of the system, in use to rate or review the experience with the public servant. In the shown embodiment, the user interface of the system 1 includes a plurality of police accountability sections (14, 15, 16) to assist the ex-offender with reviewing or rating the particular police officer. The plurality of police accountability sections includes an officer profile section 14, an officer rating section 15, and a comment section 16. In the shown embodiment, to review a particular police officer, the ex-offender may view the officer's profile with the officer profile section 14, rate the officer with the officer rating section 15, and provide a written comment or voice recording with the comment section 16. In this manner, the ex-offender may view and rate or review the officer with a single user interface screen, as depicted in FIG. 5.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

I claim:

1) A computer-implemented method for applying for a job for an ex-offender, comprising executing on a processor the steps of:
receiving a first electronic communication in a computer, from a server, that pertains to the job; wherein the computer comprises a non-transitory computer-readable medium and the processor; wherein the non-transitory computer-readable medium comprises processor-executable instructions stored thereon for receiving and sending electronic communications; wherein the job accepts applicants who have been convicted of a criminal offense;
sending a second electronic communication that pertains to one or more of a qualification, the criminal offense, a skill, or a combination thereof of the ex-offender, from the computer to the server.

2) The method of claim 1, wherein the computer comprises one or more computing devices selected from a group consisting of: a mobile phone, a tablet, a desktop computer, a laptop computer, and a combination thereof.

3) The method of claim 2, wherein the second electronic communication comprises data that pertains to a resume of the ex-offender.

4) The method of claim 1, wherein the non-transitory computer readable medium further comprises processor-executable instructions stored thereon for searching or querying the server based on a custom input.

5) The method of claim 4, wherein the custom input comprises one or more custom search parameters that identify the job, wherein the job requires one or more of the qualification, the skill, and the combination thereof.

6) A computer-implemented method for applying for a financial aid package for an ex-offender, comprising executing on a processor the steps of:
receiving a first electronic communication in a computer, from a server, that pertains to the financial aid package; wherein the computer comprises a non-transitory computer-readable medium and the processor: wherein the non-transitory computer-readable medium comprises processor-executable instructions stored thereon for receiving and sending electronic communications; wherein an application process of the financial aid package accepts applicants who have been convicted of a criminal offense;
sending a second electronic communication that pertains to one or more of a name, the criminal offense, an address, or a combination thereof of the ex-offender, from the computer to the server.

7) The method of claim 6, wherein the computer comprises one or more computing devices selected from a group consisting of: a mobile phone, a tablet, a desktop computer, a laptop computer, and a combination thereof.

8) The method of claim 7, wherein the first electronic communication comprises data that pertains to the name and the address of the ex-offender.

9) The method of claim 6, wherein the non-transitory computer readable medium further comprises processor-executable instructions stored thereon for searching or querying the server based on a custom input.

10) The method of claim 9, wherein the custom input comprises one or more custom search parameters that identify a location of a bonding company.

11) A computer-implemented method for rating a public servant, comprising executing on a processor the steps of:
receiving a first electronic communication in a computer, from a server, that pertains to the public servant; wherein the computer comprises a non-transitory computer-readable medium and the processor; wherein the non-transitory computer-readable medium comprises processor-executable instructions stored thereon for receiving and sending electronic communications; wherein an ex-offender has experienced one or more interactions with the public servant;
sending a second electronic communication that pertains to the one or more interactions from the computer to the server.

12) The method of claim 11, wherein the computer comprises one or more computing devices selected from a group consisting of: a mobile phone, a tablet, a desktop computer, a laptop computer, and a combination thereof.

13) The method of claim 12, wherein the one or more interactions pertain to an experience related to a criminal offense of the ex-offender.

14) The method of claim 11, wherein the non-transitory computer readable medium further comprises processor-executable instructions stored thereon for searching or querying the server based on a custom input.

15) The method of claim 14, wherein the custom input comprises one or more custom search parameters that identify the public servant, wherein the public servant is a police officer.
